(19) United States
(12) Patent Application Publication
(10) Pub. No.: US 2021/0089499 A1
(43) Pub. Date: Mar. 25, 2021

(54) DYNAMIC ELECTRONIC FOLDER INTERACTION WITH SOFTWARE APPLICATIONS

(71) Applicant: International Business Machines Corporation, Armonk, NY (US)

(72) Inventors: Dana L. Price, Surf City, NC (US); Heather Saunders, Raleigh, NC (US); Kelly Camus, Durham, NC (US)

(21) Appl. No.: 16/582,854

(22) Filed: Sep. 25, 2019

(51) Int. Cl. G06F 16/16; G06F 16/17; G06F 16/188; G06F 16/14

(52) U.S. Cl. CPC G06F 16/168; G06F 16/148; G06F 16/192; G06F 16/17

(57) ABSTRACT

The present disclosure discloses dynamic electronic folder interactions using an interface communicating with a computing device. A device having a computer receives a selection of a folder by a user using a user interface communicating with the computer. Settings associated with the folder are analyzed. A software application in the folder is automatically opened based on the settings of the folder.

### BACKGROUND

The present disclosure relates to electronic folder interactions in a file system of a computer, and more particularly, the electronic folder interactions including software applications within one or more folders stored in the computer.

Typically, a computer file system can have a series of folders containing, for example, files, documents, shortcuts to software applications, or software applications. The folders can be accessible at various locations on a computer, such as, on a desktop, or via a software application for displaying the folders. In one example, folders can be accessed and viewed as a directory structure or as a file tree or hierarchical tree. In another example, a computer system of a device, such as a mobile device or tablet, can also have a series of folders which can include folders on a home screen. Folders can include other applications in the folders, and have sub-folders.

In one example, a user can open a folder and select a software application, for example, by using a mouse or a touch screen, and possibly voice commands, thereby initiating opening the software application. Such a technique includes the opening of a folder, and a selection of a software application.

### SUMMARY

Opening a folder, searching for a software application, and selecting an application, requires at least two actions by a user to open the application. In one example, one action to open the folder, and one action to select a software application. In another instance, more actions are required to scroll through multiple pages of application in a folder, or to open sub-folders.

The present disclosure recognizes the shortcomings and problems associated with opening software applications manually by a user.

The present disclosure provides methods and systems for dynamic electronic folder interactions in a file system of a computer, and for the dynamic electronic folder interactions to automatically open software applications based on settings.

In one aspect according to the present invention, a method for dynamic electronic folder interactions using an interface communicating with a computing device includes receiving, at a device having a computer, a selection of a folder by a user using a user interface communicating with the computer. The method includes analyzing settings associated with the folder, and automatically opening a software application in the folder based on the settings of the folder.

In another aspect according to the present invention, a system for dynamic electronic folder interactions using an interface communicating with a computing device is disclosed. The computer system includes: a computer processor, a computer-readable storage medium, and program instructions stored on the computer-readable storage medium being executable by the processor, to cause the computer system to: receive, at a device having a computer, a selection of a folder by a user using a user interface communicating with the computer; analyze settings associated with the folder; and automatically open a software application in the folder based on the settings of the folder.

In another aspect according to the present invention, a computer program product for dynamic electronic folder interactions using an interface communicating with a computing device is disclosed. The computer program product comprising a computer readable storage medium having program instructions embodied therewith, wherein the computer readable storage medium is not a transitory signal per se, the program instructions executable by a computer to cause the computer to perform a method, comprising: receiving, at a device having a computer, a selection of a folder by a user using a user interface communicating with the computer; analyzing settings associated with the folder; and automatically opening a software application in the folder based on the settings of the folder.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system and methodology for dynamic electronic folder interactions using an interface communicating with a computing device, according to an embodiment of the invention.

FIG. 2 is a flow chart illustrating a method, implemented using the system shown in FIG. 1, for dynamic electronic folder interactions using an interface communicating with a computing device, according to an embodiment of the present invention.

FIG. 3 is an instructional and functional block diagram illustrating features of the present invention in association with the embodiments shown in FIGS. 1 and 2, for dynamic electronic folder interactions using an interface communicating with a computing device.

FIG. 4 is a schematic block diagram depicting a computer system according to an embodiment of the disclosure which may be incorporated, all or in part, in one or more computers or devices shown in FIG. 1, and cooperates with the system and methods shown in FIGS. 1-3.

FIG. 5 is a schematic block diagram of a system depicting system components interconnected using a bus. The components for use, in all or in part, with the embodiments of the present disclosure, in accordance with one embodiment of the present disclosure.

FIG. 6 is a block diagram depicting a cloud computing environment according to an embodiment of the present invention.

FIG. 7 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

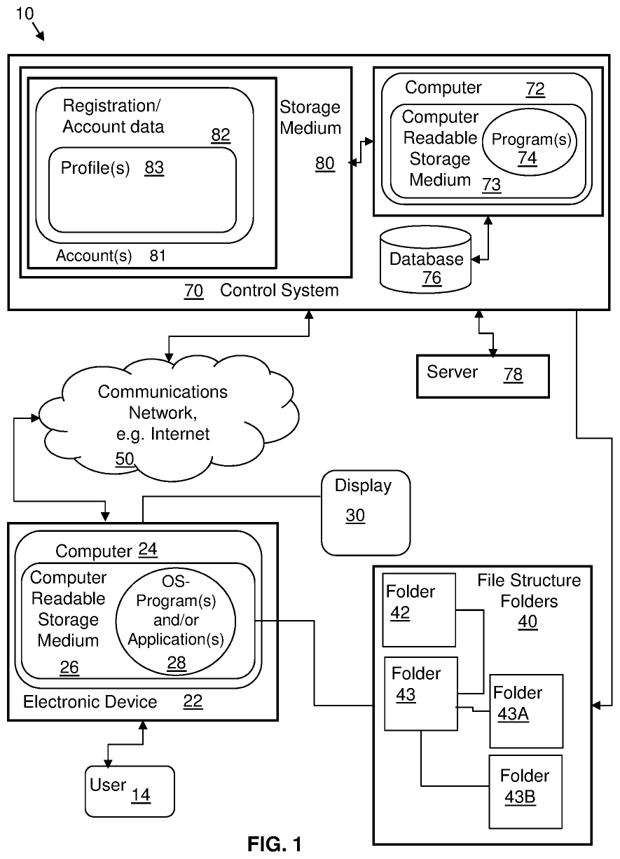

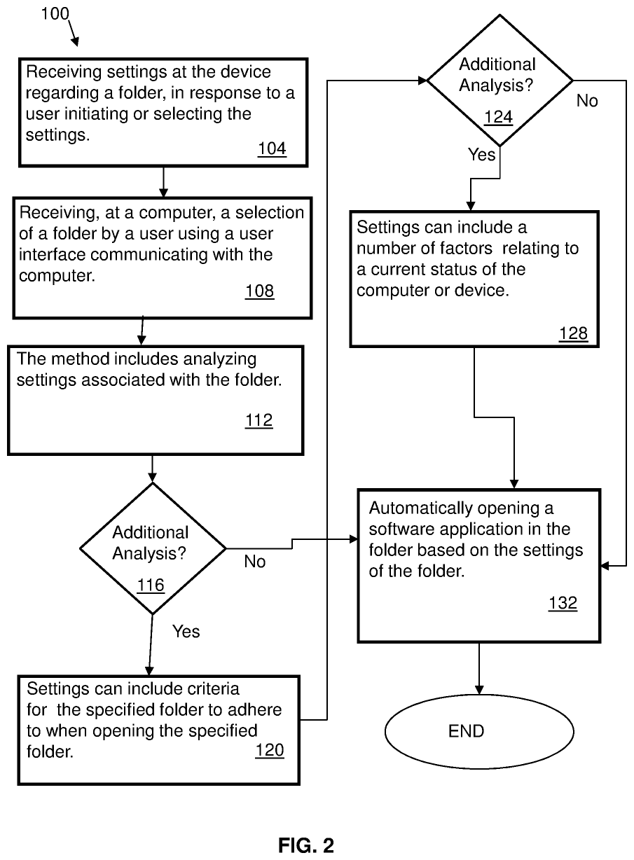

Referring to FIGS. 1 and 2, a method 100 (FIG. 2) with reference to a system 10 (FIG. 1) according to an embodiment of the present disclosure is provided for dynamic electronic folder interactions using an interface communicating with a computer device. In one embodiment according to the present disclosure, a user interface, for example, a display 30 is connected to a user electronic device 22 which can also be referred to as a ‘device’ or ‘user device’. The user device can be, for example, a computer, a laptop computer, or a desktop computer, and alternatively a mobile device, or a tablet having a computer. Additionally, the user device can be any device with an interface, such as a car interface display. The method and system of the present disclosure can be applied to one or more folders represented by a file structure folders 40 saved on a computer readable medium 26 (e.g., a hard drive) of a computer 24, and such folders are available for selection by a user 14 using the interface (e.g., display 30) connected to the computer 24 or device 22. It is understood that a device can be a computer, or a device can have a computer therein.

It is also envisioned that the folders may be stored remotely from the computer on a computer readable storage medium, for example, but not limited to, an external hard drive, remote server, or cloud storage. The folders can be displayed in the file structure 40 of a computer enabled by an operating system (OS) and/or other programs 28 of the computer 24. In one example, such file structure program can enable the creation, editing and deleting of folders and shows the file structure or folder tree stored on the hard drive of the computer. It is understood that one or more folders in accordance with the present disclosure can be placed, saved, or displayed on the computer by the choice of the user, at many locations on the computer and displayed on the computer display or screen as enabled by the software on the computer, for example, on the desktop, or as a folder with sub-folders. In one example, the file structure folders 40 shows folders including folder 42 and folder 43. Folder 43 includes subfolders 43A and 43B. It is understood that the file structure folders 40 are one example, and representative of one or more folders, a plurality of folders, and many variations of folders and subfolders.

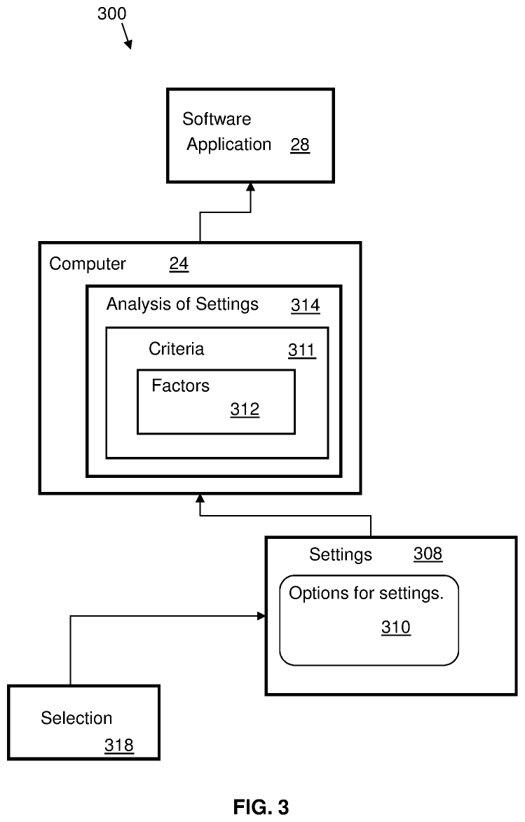

Referring to FIG. 2, the method 100 includes receiving settings at the device 22 regarding a folder (in another example, the settings can apply to one or more folders), in response to a user initiating or selectin the settings, as in block 104. The settings 308 (shown in FIG. 3 and represented as block 308) being selected by the user 14 using the display 30. In one example, the user can use a mouse for selecting options 310 (FIG. 3) on the display 30 for applying settings 308 to one or more folders 40. In another example, the user can use a touch display for selecting settings or options for settings for application to one or more folders. The settings can include folder options regarding opening a software application (also referred to as an application) in the folder.

The selection 318 (FIG. 3) of a folder or interaction by a user for selection of a folder on a display can include, for example, a long-press, 3D (3-dimensional) touch, double-tap, or touch screen selection, by pressing using a user's finger, or using a mouse by clicking, pressing, or double-click, etc.

In one or more examples, the settings can be initiated by the user by selection as described above, and received by the computer for application to the folder. Such selections can include one or more settings including: opening a last software application added to the folder; or opening a specified or selected software application in the folder; or opening the most frequently used application in the folder.

In one or more examples, the settings can be automatically applied to one or more folders based on or using historical data of usage of the device, and thereby the user's usage history. For example, the system and method according to an embodiment of the disclosure can include using historical data of usage of the device, and based on the historical usage data, automatically apply a setting to open the last previously opened application, and in other examples, apply settings to open: a most frequently used application, or a last added application. In another example, the method and system can detect a location of the device, and automatically apply a setting based on the location of the device, such as applying a setting to open a specific application when at an airport, or inside a theater. In another example, the method and system can automatically apply a setting based on a mode of the device, such as a night mode, a low power mode, or an airplane mode. The method and system can apply settings to one or more folders based on the mode of the device, thereby opening an application in a folder based on the setting of the folder which is in turn based on a mode of the device. Similarly, the folder settings can be automatically applied based on a location of the device, and alternatively the folder setting can be set manually by the user as received by the computer in response to one or more selections by the user.

Returning to FIG. 2, the method 100 includes receiving, at a computer, a selection of a folder, for example folder 42 by a user using a user interface communicating with the computer, as in block 108.

The method includes analyzing the settings 314 (FIG. 3) associated with the folder, as in block 112. Such analysis can include determining the setting or settings which can include, and/or indicate, one or more folder settings which can include, for example, a setting opening a designated application by the user in the folder, in response to the folder settings.

In another example, a setting can include opening a first application added to the folder, in response to the folder settings. In another example, a setting can include opening a most recently added application to the folder, in response to the folder settings. In another example, a setting can include associating the folder to a user profile, the user profile having settings on a folder-by-folder basis for each of a plurality of folders saved on the computer.

According to the embodiment of the present disclosure, including the examples set forth herein, but not limited to, a user does not manually select the software application subsequent to the selection of the folder.

The method and system includes determining when additional analysis is included, as in block 116. When the method determines that there is no additional analysis of the settings, the method continues to automatically open the software application in the folder based on the settings of the folder, as in block 132.

Also, referring to FIG. 1, a user's electronic device 22 can include a computer 24, computer readable storage medium 26, and operating systems, and/or programs, and/or a software application 28. These features are shown generically herein.

The method 100 according to an embodiment of the present disclosure, can be incorporated in one or more computer programs or a software application, and stored on an electronic storage medium (e.g., a computer readable storage medium). It is envisioned that the application can access all or part of instructions necessary to implement the method of the present disclosure. The program or application on the device 22 (e.g., a local device) can communicate with a remote computer system, such as the control system 70 via a communications network 50, e.g., the Internet, and access data, and cooperate with program(s) stored on the control system. In the embodiment of the disclosure shown in FIGS. 1 and 2, the method 100 is incorporated in a program or application 28, which can also be referred to as a software application 28 and stored on the device 22. The application can communicate with the control system 70 via a communications network 50. The control system 70 includes a computer 72 including one or more programs 74 stored on a computer readable storage medium 73. The control system 70 also includes the computer 72 communicating with a database 76. In the embodiment of the disclosure shown in FIG. 1, the application 28 communicates with the control system 70 and the one or more programs 74 of the control system 70 computer 72.

In one embodiment of the present disclosure, the control system 70 includes a storage medium 80 for maintaining a registration and account data 82 of accounts 81. The registration and account data 82 can include associated profiles 83. The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device of a user, as in the example shown in FIG. 1 of device 22 having the application 28. The application 28 is stored on the device 22 and can access data and additional programs at the back end of the application, for example, in the program(s) 74 stored in the control system 70.

It is also understood that the method 100 according to an embodiment of the present disclosure, can be incorporated in (Artificial Intelligence) AI devices, which can communicate with respective AI systems, and respectively AI system platforms. The platforms can be enabling for the AI systems and the devices that employ them. Thereby, such programs or an application incorporating the method of the present disclosure, as discussed above, can be part of an AI system.

In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system.

In one embodiment according to the present disclosure, the method and system of the present disclosure can include receiving, at the computer, one or more settings from the user for a specified folder.

When the method determines that additional analysis is included in the setting(s), in one embodiment, the method continues to determine that the settings can include criteria 311 (FIG. 3) for the specified folder to adhere to when opening the specified folder, as in block 120. For example, a setting for a folder can include the instruction to open the last added software application to the folder with a criterion that the device not being located at an airport. The implication being that a user at an airport can only open certain applications. In this example, the criteria can further include an instruction to open a specified application when the device is located at an airport or in the vicinity of an airport. The method applies the settings to the specified folder. The method includes initiating opening a software application in the specified folder based on the settings including the criteria, in response to receiving a selection of the specified folder by the user. The method further includes automatically opening the software application in the folder based on the settings including the criteria such that the user does not manually select the software application.

In another example, the criteria can include historical data of usage by the user related to the specified folder.

The method can further determine if additional analysis is included by the settings in block 124. When no additional analysis is included, the method continues to block 132 to automatically open a software application in the folder based on the settings, including the criteria, of the folder as in block 132.

When the method determines additional analysis is included in the settings in block 124, the method continues, in one embodiment, to detect in the settings a number of factors 312 (FIG. 3) relating to a current status of the computer or device 22, as in block 128. For example, the factors can include a time of day, or whether the computer or device is in a night mode, or a power saving mode. The method includes applying the factors as part of the settings of a folder. The method further includes automatically opening a software application in the folder based on the settings of the folder which includes the factors.

In one example, a factor of the number of factors includes a location and/or micro-location of the computer detecting using GPS (Global Positioning System).

Once the settings including the factors are analyzed in block 128, the method continues to automatically open a software application in the folder based on the settings, including the factors, and in one example including the criteria and the factors, of the folder, as in block 132.

In one embodiment according to the present disclosure, the method and system of the present disclosure can include receiving, at the computer or device, one or more settings from the user for a specified folder. The settings can include criteria for the specified folder to adhere to when opening the specified folder. The criteria can include historical data of usage by the user related to the specified folder. The method includes detecting a number of factors relating to a current status of the device, wherein the current status can include a location of the device. The method can further include applying the criteria and the factors as part of the settings for a specified folder. The method can further include analyzing the settings including the criteria and the factors in relation to the specified folder. The method further includes initiating opening the software application in the specified folder based on the settings including the criteria and the factors, in response to the selection of the specified folder by the user. The method includes automatically opening a software application in the specified folder based on the settings including the criteria and the factors.

### OTHER EMBODIMENTS

In one embodiment, multiple software applications can be included in a folder and sub-folders. Settings of the folder can include a criterion to open an application in concert with a location of the device as a factor for analysis. In one example, a criterion can include opening a group meeting application (e.g., team collaborative software application) when the device (and thereby the user) is at a work location. In another example, a criterion can include opening a game application when the device is at an airport. In another example, a criterion can include, in response to a detected location of the device, not opening a first application and opening a second application. For example, when the device is detected being in an airport, not opening a group gaming application, and opening an individual game for the user. Similarly, a criterion can include instructions to not open a gaming application when the device is detected at a work location and opening a group meeting application.

In another example, the settings can include determining user patterns of usage on the device or computer based on a system threshold, the method and system can modify the settings for opening a software application associated with a folder. In one example, a percentage of the time a user opens each application in a folder can be determined. Based on the determination, the settings can initiate opening the application which is opened the highest percentage of time when opening the folder.

In the embodiments and examples of the present disclosure, the methods and systems result in less keystrokes and/or screen touches or selections by a user. The embodiments of the present disclosure can include reduced data plan consumption by eliminating searching for an application in a folder and sub-folders, as a result of an automatic opening of a software application based on settings as described herein. This reduces the time a screen needs to be lit. Screen lighting consumes power, and thus the reduction of time necessary for the screen to be lit to make sections, saves power.

One embodiment of the present disclosure can include a method and system according to the present disclosure where settings include modifying a folder icon to indicate a folder selection application within the folder. That is, indicating the application selected by the setting within the folder, and thus automatically opening the indicated application based on the settings and in response to a user selecting the folder.

In another embodiment according to the present disclosure, settings can include an option to reject the folder setting, and thereby not open the folder application based on the settings, and view the folder contents, and thereby manually select a software application.

In another embodiment according to the present disclosure, settings can include opening one application when the device is connected to Wi-Fi and another application when the device is not connected to Wi-Fi and may be connected to a data driven usage plan.

In another example, the folder can include a visual indication of which application will be opened in response to selection of the folder by the user and in response to the settings for opening an application for the folder. Such visual indication with respect to the folder can include, for example, an icon indicating the application to be opened as a result of the settings, or changing the folder name to include the name of the application to be opened. In another example, a list of folders and associated applications for opening based on settings can be stored, and available for access and viewing by the user, and updated periodically or as settings are changed. Such a list can name the application to be opened for a folder based on the settings as a “folder selection application”, or alternatively, as a “folder settings selected application”. In another example, the method and system of the present disclosure can send a notification to the device or another device as, for example, an email or a text number to notify the user of changes in settings to a folder.

More particularly, the control system 70 can include user-initiated profiles 83 saved in a computer readable storage medium 80 and/or in a database 76, which are shown in FIG. 1 as part of the control system 70. The control system 70 includes one or more programs 74. The programs 74 can be stored on a computer readable storage medium 73 in a computer 72 of the control system 70. Likewise, the control system 70 can be connected to a server 78. Such server 78 can include a computer readable storage medium similar to the computer 72. The program(s) 74 can include, all or in part, a series of executable steps for implementing the method of the present disclosure. A program, incorporating the present method, can be all or in part stored in the computer readable storage medium on the control system or, in all or in part, on a user device such as a device 22. It is envisioned that the control system can not only store the profile of users, but in one embodiment, can interact with a website for viewing on the Internet and receive user input related to the method and system of the present disclosure. It is understood that FIG. 1 depicts one or more profiles 83, however, the method can include multiple profiles, users, registrations, etc. It is envisioned that a plurality of users or a group of users can register and provide profiles using the control system to share one or more photos, camera feeds, etc., for use according to the method and system of the present disclosure.

Regarding any collection of data with respect to the present disclosure, such as uploading or generating profiles is voluntary by the one or more users, and thus initiated by and with the approval of a user. Thereby, a user can opt-in to establish an account 81 having a profile 83 according to the present disclosure. Such approval also includes a user's option to cancel such profile or account, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

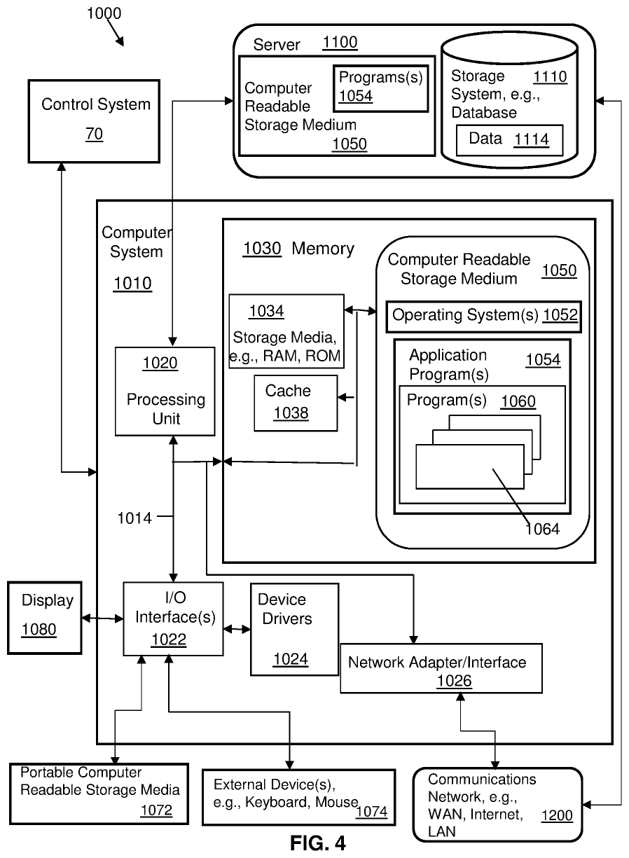

Referring to FIG. 4, a system or computer environment 1000 includes a computer system 1010 shown in the form of a generic computing device. The method 100, for example, may be embodied in a program 1060, including program instructions, embodied on a computer readable storage device, for example, generally referred to as memory 1030 and more specifically, computer readable storage medium 1050. Such memory and/or computer readable storage media can include non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 can include all or part of the computer system 1010 and its components, and/or the control system can communicate with all or part of the computer system 1010 and its components as a remote computer system, to achieve the control system functions described in the present disclosure. It is also understood that the one or more computers or computer systems shown in FIG. 1 similarly can include all or part of the computer system 1010 and its components, and/or the one or more computers can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

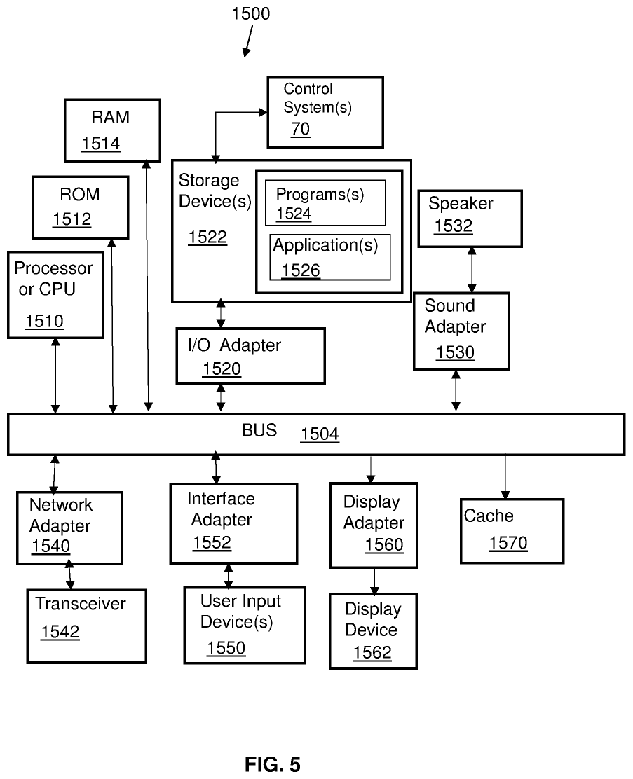

Referring to FIG. 5, an example system 1500 for use with the embodiments of the present disclosure is depicted. The system 1500 includes a plurality of components and elements connected via a system bus 1504 (also referred to as a bus). At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. The storage device can include, for example, but not limited to, a hard drive or flash memory and be used to store one or more programs 1524 or applications 1526. The programs and applications are shown as generic components and are executable using the processor 1510. The program 1524 and/or application 1526 can include all of, or part of, programs or applications discussed in the present disclosure, as well vice versa, that is, the program 1524 and the application 1526 can be part of other applications or program discussed in the present disclosure. The storage device can communicate with the control system 70 which has various functions as described in the present disclosure.

A speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

One or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

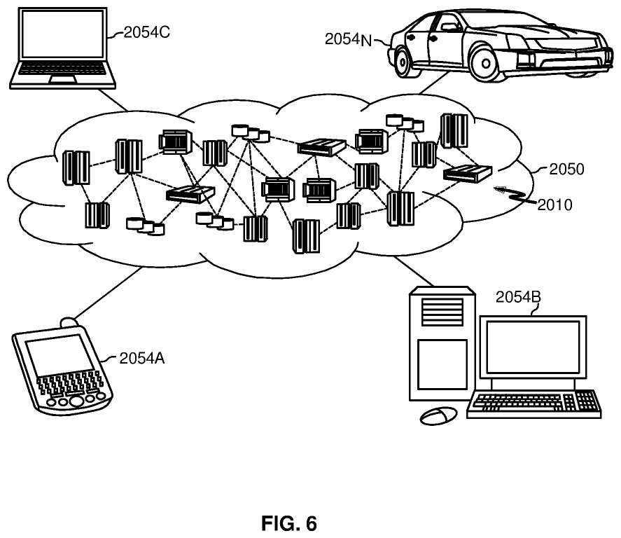

Referring now to FIG. 6, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 6 are intended to be illustrative only and that computing nodes 2010 and cloud computing environment 2050 can communicate with any type of computerized device over any type of network and/or network addressable connection (e.g., using a web browser).

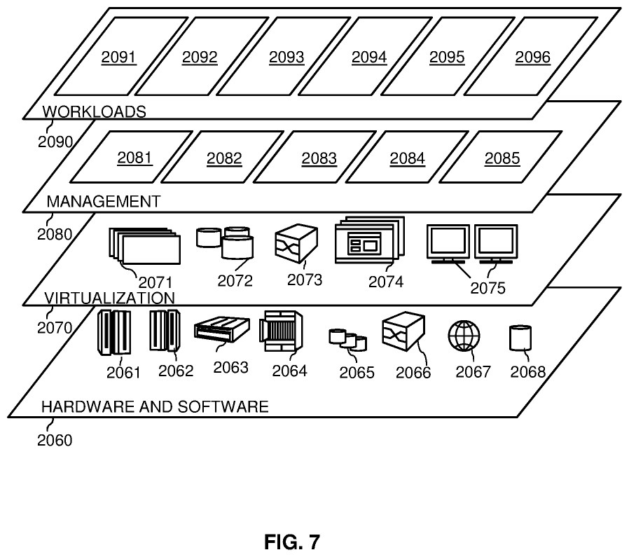

Referring now to FIG. 7, a set of functional abstraction layers provided by cloud computing environment 2050 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and dynamic electronic folder interactions using an interface communicating with a computing device 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for dynamic electronic folder interactions using an interface communicating with a computing device, comprising:
receiving, at a device having a computer, a selection of a folder by a user using a user interface communicating with the computer;
analyzing settings associated with the folder;
determining user patterns of usage on the device based on a threshold, as part of the settings;
modifying the settings for opening a software application associated with a folder based on the determined user patterns of usage; and
automatically opening the software application in the folder based on the modified settings of the folder.

2. The method of claim 1, further comprising:
opening a designated application by the user in the folder, in response to the folder settings.

3. The method of claim 1, further comprising:
opening a first application added to the folder, in response to the folder settings.

4. The method of claim 1, further comprising:
opening a most recently added application to the folder, in response to the folder settings.

5. The method of claim 1, further comprising:
associating the settings of the folder to a user profile, the user profile having settings on a folder-by-folder basis for each of a plurality of folders saved on the computer.

6. The method of claim 1, wherein the user does not manually select the software application subsequent to the selection of the folder, the software application being automatically opened in the folder based on the settings of the folder.

7. The method of claim 1, further comprising:
receiving, at the computer, one or more settings from the user for a specified folder, the settings including criteria for the specified folder to adhere to when opening the specified folder;
applying the settings to the specified folder;
initiating opening a software application in the specified folder based on the settings including the criteria, in response to receiving a selection of the specified folder by the user; and
automatically opening the software application in the folder based on the settings including the criteria such that the user does not manually select the software application.

8. The method of claim 7 wherein the criteria includes historical data of usage by the user related to the specified folder and related to applications in the specified folder.

9. The method of claim 1, further comprising:
detecting a number of factors relating to a current status of the computer;
applying the factors as part of the settings of a folder;
automatically opening a software application in the folder based on the settings of the folder which includes the factors.

10. The method of claim 1, wherein a factor of the number of factors includes a location and/or micro-location of the computer detected using GPS (Global Positioning System).

11. The method of claim 1, further comprising:
receiving, at the device, one or more settings from the user for a specified folder, the settings including criteria for the specified folder to adhere to when opening the specified folder, the criteria including historical data of usage by the user related to the specified folder;
detecting a number of factors relating to a current status of the device, the current status including a location of the device;
applying the criteria and the factors as part of the settings for a specified folder;
analyzing the settings including the criteria and the factors in relation to the specified folder;
initiating opening the software application in the specified folder based on the settings including the criteria and the factors, in response to the selection of the specified folder by the user; and
automatically opening a software application in the specified folder based on the settings including the criteria and the factors.

12. A system for dynamic electronic folder interactions using an interface communicating with a computing device, which comprises:
a computer system comprising: a computer processor, a computer-readable storage medium, and program instructions stored on the computer-readable storage medium being executable by the processor, to cause the computer system to:
receive, at a device having a computer, a selection of a folder by a user using a user interface communicating with the computer;
analyze settings associated with the folder;
determine user patterns of usage on the device based on a threshold, as part of the settings;
modify the settings for opening a software application associated with a folder based on the determined user patterns of usage; and
automatically open a software application in the folder based on the settings of the folder.

13. The system of claim 12, which further causes the computer system to:
receive, at the computer, one or more settings from the user for a specified folder, the settings including criteria for the specified folder to adhere to when opening the specified folder;
apply the settings to the specified folder;
initiate opening a software application in the specified folder based on the settings including the criteria, in response to receiving a selection of the specified folder by the user; and
automatically open the software application in the folder based on the settings including the criteria such that the user does not manually select the software application.

14. The system of claim 13 wherein the criteria includes historical data of usage by the user related to the specified folder and related to applications in the specified folder.

15. The system of claim 12, which further causes the computer system to:
detect a number of factors relating to a current status of the computer;
apply the factors as part of the settings of a folder;
automatically open a software application in the folder based on the settings of the folder which includes the factors.

16. The system of claim 12, wherein a factor of the number of factors includes a location and/or micro-location of the computer detected using GPS (Global Positioning System).

17. The system of claim 12, which further causes the computer system to:
receive, at the device, one or more settings from the user for a specified folder, the settings including criteria for the specified folder to adhere to when opening the specified folder, the criteria including historical data of usage by the user related to the specified folder;
detect a number of factors relating to a current status of the device, the current status including a location of the device;
apply the criteria and the factors as part of the settings for a specified folder;
analyze the settings including the criteria and the factors in relation to the specified folder;
initiate opening the software application in the specified folder based on the settings including the criteria and the factors, in response to the selection of the specified folder by the user; and
automatically open a software application in the specified folder based on the settings including the criteria and the factors.

18. A computer program product for dynamic electronic folder interactions using an interface communicating with a computing device, the computer program product comprising a computer readable storage medium having program instructions embodied therewith, wherein the computer readable storage medium is not a transitory signal per se, the program instructions executable by a computer to cause the computer to perform a method, comprising:
receiving, at a device having a computer, a selection of a folder by a user using a user interface communicating with the computer;
analyzing settings associated with the folder;
determine user patterns of usage on the device based on a threshold, as part of the settings;
modify the settings for opening a software application associated with a folder based on the determined user patterns of usage; and
automatically opening a software application in the folder based on the settings of the folder.

19. The computer program product of claim 18, further comprising:
receiving, at the computer, one or more settings from the user for a specified folder, the settings including criteria for the specified folder to adhere to when opening the specified folder;
applying the settings to the specified folder;
initiating opening a software application in the specified folder based on the settings including the criteria, in response to receiving a selection of the specified folder by the user; and
automatically opening the software application in the folder based on the settings including the criteria such that the user does not manually select the software application.

20. The computer program product of claim 19 wherein the criteria includes historical data of usage by the user related to the specified folder and related to applications in the specified folder.
